(19) United States
(12) Patent Application Publication
(10) Pub. No.: US 2024/0288175 A1
(43) Pub. Date: Aug. 29, 2024

(54) TEMPERATURE SENSING DEVICE

(71) Applicant: Impulse Labs, Inc., San Francisco, CA (US)

(72) Inventors: Samuel Redmond D'Amico, San Francisco, CA (US); Samuel William Lenius, Palo Alto, CA (US); Jacob Russell Davis, San Francisco, CA (US); Katherine Stegner, San Francisco, CA (US); Bradley James Tallon, Los Angeles, CA (US)

(21) Appl. No.: 18/586,274

(22) Filed: Feb. 23, 2024

Related U.S. Application Data
(60) Provisional application No. 63/486,632, filed on Feb. 23, 2023.

(51) Int. Cl. F24C 7/08; G01K 1/14

(52) U.S. Cl. CPC F24C 7/081; G01K 1/14

(57) ABSTRACT

A temperature sensing device for an induction stove and a method for assembling the temperature sensing device are described. An example temperature sensing device includes a sensor package including one or more sensors, a plunger assembly configured to hold the sensor package, and a support base configured to provide a physical support for the plunger assembly.

### CROSS-REFERENCE TO RELATED APPLICATIONS

This application claims the benefit and priority under 35 U.S.C. § 119(e) of U.S. Provisional Patent Application No. 63/486,632 titled “TEMPERATURE SENSING DEVICE” and filed on Feb. 23, 2023, which is hereby incorporated by reference herein in its entirety.

### TECHNICAL FIELD

The present disclosure generally relates to temperature sensing device, and more particularly to methods and apparatuses for precise temperature sensing for arbitrary cookware made of different types of materials.

### BACKGROUND

In the related art, there are several existing induction stoves utilizing temperature sensing for heating control. However, existing induction stoves are often limited by the variability in the types of cookware used. At the same time, temperature measurement differs across the different types of materials, resulting in inconsistent results being generated from the associated temperature sensors.

Accurate measurement of cookware temperature is essential for accurate temperature control of the cookware that is being used. Accurate measurement of the rate of change of the cookware temperature is necessary for safety (e.g., to prevent temperature spikes on startup or with empty cookware) and for reducing overshoot of the setpoint temperature and minimizing temperature oscillations (i.e., know how much power is required to change the temperature by a certain amount).

Accordingly, a need exists for a temperature-sensing device that works universally with different types of materials and is capable of providing accurate and precise temperature measurements for controlling cookware temperature while working with a minimal time lag (i.e., the amount of time between reaching a desired temperature and registering of this temperature at the temperature sensor or by the system).

### SUMMARY

To address the aforementioned shortcomings, a temperature sensing device for an induction stove and a method for assembling the temperature sensing device are described. In certain examples, the temperature sensing device includes a sensor package including one or more sensors, a plunger assembly configured to hold the sensor package, and a support base configured to provide a physical support for the plunger assembly.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments

### BRIEF DESCRIPTION OF THE DRAWINGS

Various implementations in accordance with the present disclosure will be described with reference to the drawings, in which:

FIG. 1 illustrates example sensor response time and time constant response to a step change in temperature, according to an implementation.

FIG. 2 illustrates an example thermal response of an aluminum pan to an input power, according to an implementation.

FIG. 3 illustrates an example configuration for placing a temperature sensor subsystem inside a stove, according to an implementation.

FIGS. 4A and 4B illustrate different sectional views of an example architecture of a temperature sensor subsystem, according to an implementation.

FIG. 5 illustrates an exploded view of an example plunger assembly, according to an implementation.

FIG. 6 illustrates an example support base and additional sensor, according to an implementation.

FIG. 7 illustrates example electronics included in a temperature sensor subsystem, according to an implementation.

### DETAILED DESCRIPTION

The Figures (FIGS.) and the following description relate to some embodiments by way of illustration only. It should be noted that from the following discussion alternative embodiments of the structures and methods disclosed herein will be readily recognized as viable alternatives that may be employed without departing from the principles of the present disclosure.

Reference will now be made in detail to specific embodiments, examples of which are illustrated in the accompanying figures. It should be noted that wherever practicable similar or like reference numbers may be used in the figures and may indicate similar or like functionality. The figures depict embodiments of the disclosed sensor design for purposes of illustration only. One skilled in the art will readily recognize from the following description that alternative embodiments of the structures and methods illustrated herein may be employed without departing from the principles described herein.

In general, accurate and precise measurement of cookware temperature is essential in preventing overheating and underheating in food preparation. One of the challenges in achieving fine temperature measurement lies in the wide array of vessels used in cookware. For example, cookware materials and cookware dimensions such as thickness and size have an impact on the heating and temperature measuring processes.

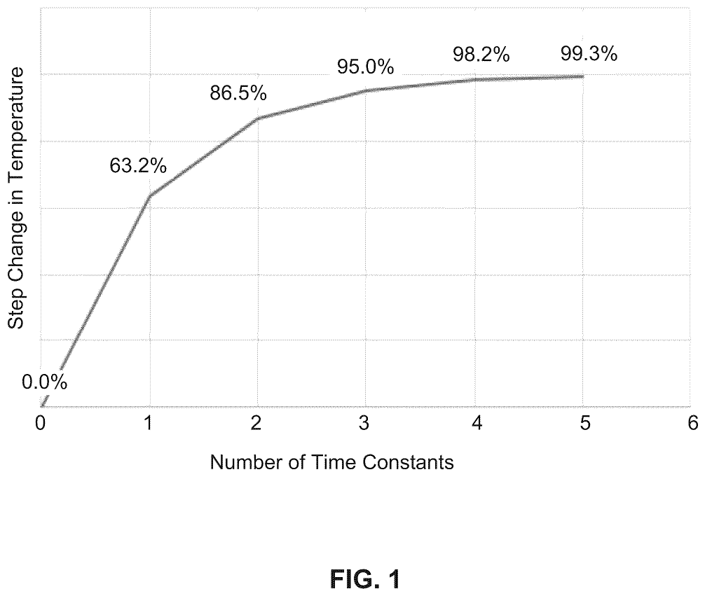

In addition to accurate and precise temperature measurement, response time is also an important element in proper temperature control. Response time is critical to the performance of the control loop, and particularly to the safety of the cooking system during the initial ramp to the setpoint temperature for unknown cookware. Response time for cookware sensors generally refers to the time required to detect 99.3% (or a close value) of a step change in temperature. For contacting sensors, such as thermocouple (TC), resistance temperature detector (RTD), thermistor and the like, measurement is generally performed by immersing the sensor in boiling water and recording the time it takes to register 99.3% (which may be 5× time constants) of the signal. FIG. 1 illustrates an exemplary sensor response time and time constant response to a step change in temperature, according to an implementation.

For a photodiode sensor, the response time is limited by how quickly charge accumulates in the semiconductor. The short response time of a photodiode makes it well suited for detecting rapid changes in temperature, but the dependence on emissivity either requires a known emissivity coating on the cookware or means for which the absolute temperature is unknown until calibration with a sensor such as a contact sensor.

Despite the relatively slow response time of contacting sensors (e.g., TC, RTD, thermistor), these sensors may be oversampled (e.g., sampled at a rate>>Nyquist rate) and their dynamic response may be measured. A model of a contacting sensor may be used to estimate the actual temperature from a few samples. The rate of change of the sensor temperature may be determined with a delay of the nominal sampling rate (e.g., a minimum of 2× readings may be required to determine a slope) or immediately by implementing an analog differentiator.

An induction stove's controller may have different, and somewhat conflicting, performance priorities for different operational states. In particular, nominal stove operation may be broken up into two different stages: (1) initial heating of an unknown cookware to a setpoint temperature; and (2) maintaining the temperature of a known cookware at the setpoint temperature.

Under the initial heating stage, the goal is to get a cookware with an unknown heat capacity to the setpoint temperature as quickly as possible in a safe and controlled manner. This is the first stage of the control loop, starting after a user inputs a setpoint temperature and ending once the cookware is close to that temperature. The challenge in this stage is that the system does not have information about the heat capacity or any other physical properties of the cookware, and thus may heat the cookware too quickly. Response time (or time constant) is more important than accuracy at this stage, to avoid dangerous conditions such as auto-ignition of canola oil, which may happen in as little as 1.2 s in a thin (e.g., 1 mm wall) aluminum pan (e.g., with 10 kW input power).

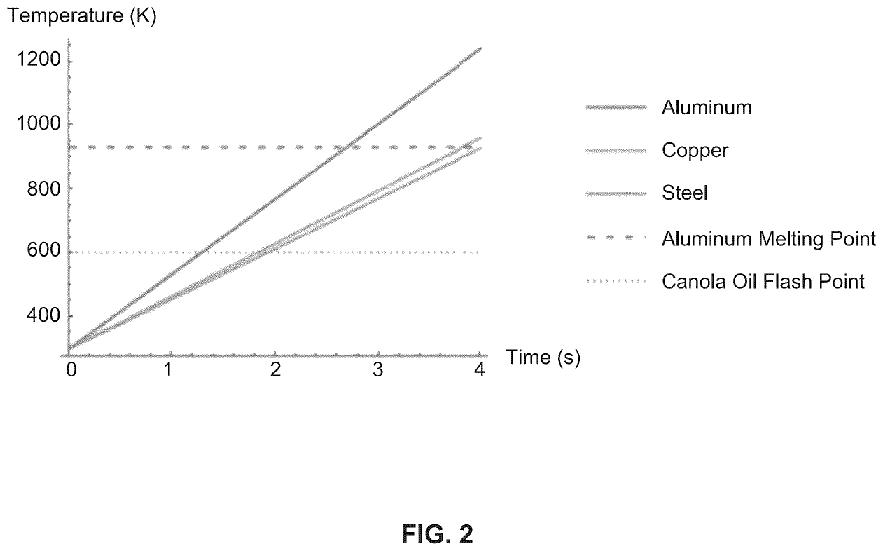

FIG. 2 illustrates an exemplary thermal response of a cookware to 10 kW input power, according to an implementation. In the figure, Y-axis represents the temperature in ° K and X-axis represents time in seconds. At the end of the initial heating stage, the temperature of the cookware may be at or near the setpoint, and the system may have data or knowledge about the thermal response of the cookware to the power input at this point.

Under the temperature maintenance stage, the goal is to maintain the temperature of a hot cookware at the setpoint as accurately as possible in a safe and controlled manner. This is the second stage of the control loop, starting once the cookware is at or near the setpoint temperature, which is also the main operational stage of the stove. Accuracy is more important than sensing speed at this stage, because the stove already has information about the thermal response of the cookware to the power input and may modulate the power supplied to maintain the temperature at the setpoint. Unlike the initial heating stage, where the best performance (fastest heating) is achieved by providing full power to the cookware, power modulation is more critical during the temperature maintenance stage.

Several options are available for modulating power to the cookware:
Modulate the amplitude of the coil excitation at the nominal frequency (i.e., the frequency labeled on an oscillator's output). This approach offers the highest resolution control over the power and does not require additional characterization of the cookware. Possible solutions to this approach include the variable amplifier architecture and thermal dissipation of the amplifier;
Duty cycle the power at the nominal frequency for the cookware and 100% amplitude through pulse width modulating the power switches. Possible solutions to this approach include the switching speed of the power electronics, thermal dissipation of the switches, and electromagnetic shielding (EMI shielding) of the rest of the system from the switching transients; and
Modulate the frequency of the coil excitation at 100% amplitude-effectively modulating the skin depth of the power transfer to the cookware. In this approach, the coils may be driven at 100% power. This approach may require some characterization of the cookware's thermal response to different frequencies, which may possibly be performed as a part of the initial heating stage.

### Sensor Architecture

Disclosed herein is a temperature sensing system. In one example, the temperature sensing system may be a part of a stove element that delivers large amounts of power (and thus is also referred to as the “temperature sensor subsystem” of an induction stove). In some implementations, the temperature sensor subsystem may be used to control cookware to a precise temperature with a very high ramp rate and a very low lag. The temperature sensor subsystem may be positioned in the center of the stove coil within an induction stove, thereby allowing the temperature sensor included in the subsystem to make consistent contact with cookware placed on the stove element. The temperature sensor may be also referred to as the “contact sensor” throughout the specification. In some implementations, the temperature sensor subsystem may automatically detect whether a cookware is placed on the stove element, so as to determine whether to activate the temperature sensor subsystem. If the stove is accidentally turned on without a cookware placed on the stove element, the temperature sensor subsystem and power output from the main coil may be not activated for safety reasons.

In some example implementations, the temperature sensor subsystem may be actively driven by utilizing an internal heater inside the sensor subsystem itself. In one example, the sensor disclosed herein may be a self-heated flux sensor that generates the heat using an internal heater inside the flux sensor itself. Here, the flux sensor is a transducer that generates an electrical signal proportional to the total rate applied to the surface of the sensor. In some implementations, this actively driven approach combines the rapid response time of the temperature derivative approach to sensing with the precision of a contact sensor with a small thermal time constant in direct contact with the cookware. In one exemplary application, during the pre-heating stage of the contact sensor, once a user inputs a temperature setpoint for the induction stove, the contact sensor may be rapidly heated to that setpoint with a control system utilizing a proportional integral derivative (PID) control loop. Because the thermal response of the contact sensor is known, heating may be done rapidly and safely. In operation, the contact sensor may be in contact with the cookware, and some steady (in the short term) amount of power may be provided to maintain the contact sensor at a target temperature due to environmental losses.

During the cookware heating stage, once the contact sensor has stabilized at the setpoint temperature, the high-power stove coils for heating the cookware may be turned on at 100% power. The cookware's temperature may increase linearly with a slope dependent on the heat capacity. Once the cookware reaches the contact sensor temperature, the coil controller may cut the power and cease the heating process on the cookware. The trigger for this power cutting may be not the absolute temperature of the contact sensor (which is limited by its response time), but rather the direction of the heat flux into the contact sensor (which may change instantly once the cookware exceeds the contact sensor temperature). Heat flux here refers to the flow of thermal energy. Two exemplary approaches for measuring the heat flux include:
Intermittently cutting power to the sensor heater, and observing the rate of change of the temperature. The cookware is at the setpoint temperature when the rate of change switches from negative (the sensor is being heated by the sensor's internal heater) to positive (the sensor is being heated passively by contact with the pan). A control sensor with the same geometry as the contact sensor, but thermally insulated from the cookware, may be used as the other end of a differential measurement to remove environmental effects.
Observing the sensor controller's commanded power output. The cookware is at the sensor temperature when the commanded power switches from positive to negative. The control system may account for heat flux leakage into the environment. This is a function of the system implementation and may additionally vary between individual devices. Calibration may be required.

By detecting the change in heat flux into the contact sensor at the setpoint temperature rather than the absolute temperature of the cookware, the issues of thermal lag due to contact resistance and heat capacity of the contact sensor may be avoided. A minimum of two samples may be required to determine the heat flux, so the sampling rate of the sensors may be maximized during this operating stage.

During the cooking stage, once the temperature of the cookware has stabilized at the temperature of the contact sensor, the contact sensor's heater power is turned off and it becomes a passive contact sensor. The response time of the contact sensor is less important during the cooking operation stage because the temperature will not be rapidly changing. The contact sensor may be sampled slowly (e.g., on the order of 2 Hz), and the coil controller may use a traditional PID loop or other control mechanisms to maintain the cookware temperature at the setpoint.

It should be noted that the above descriptions are merely some exemplary implementations, and the temperature sensor subsystem disclosed herein is not limited to these implementations, but may execute other different implementations.

### Some Features

Here the following are some identified features for the disclosed temperature sensor subsystem (or the contact sensor) and the associated induction stove:

### Physical Features:

Sensor package (i.e., temperature sensor and the immediate accessories such as sensor cap) is in contact with the cookware bottom surface.
Sensor may be displaced vertically as well as slightly at an angle to maintain contact with cookware of various sizes and geometries across a range of physical placements on the cooking surface.
Sensor package is thermally isolated from the stove element with a minimum resistance of a predefined value.

### Safety/Performance Features:

Sensor is capable of detecting cookware placement so it does not run when not in contact with a pan.
Top surface of the contact sensor is capable of surviving continuous contact with a vessel in excess of 250° C.
Other components (besides the top surface) of the contact sensor are capable of surviving temperatures exceeding 100° C.

### User Interaction Features:

Displaced and static cooktop components are easy to clean and do not trap food particles.
Exposed materials (such as sensor cap, sliding ramp, etc.) are scratch-proof, and also prevent scratches to cookware surfaces.

### Assembly/Manufacturing-Related Features:

Sensor package requires minimal per-unit calibration.
Contact sensor is capable of being verified before installation into the cooktop.
Range of fastener types and sizes are minimized.
Use of adhesives is minimized, and the used adhesives withstand certain temperatures (e.g., temperatures exceeding 100° C.).
Sensor assembly methodology enables repair and replacement of componentry.

### Mechanical Design and Integration

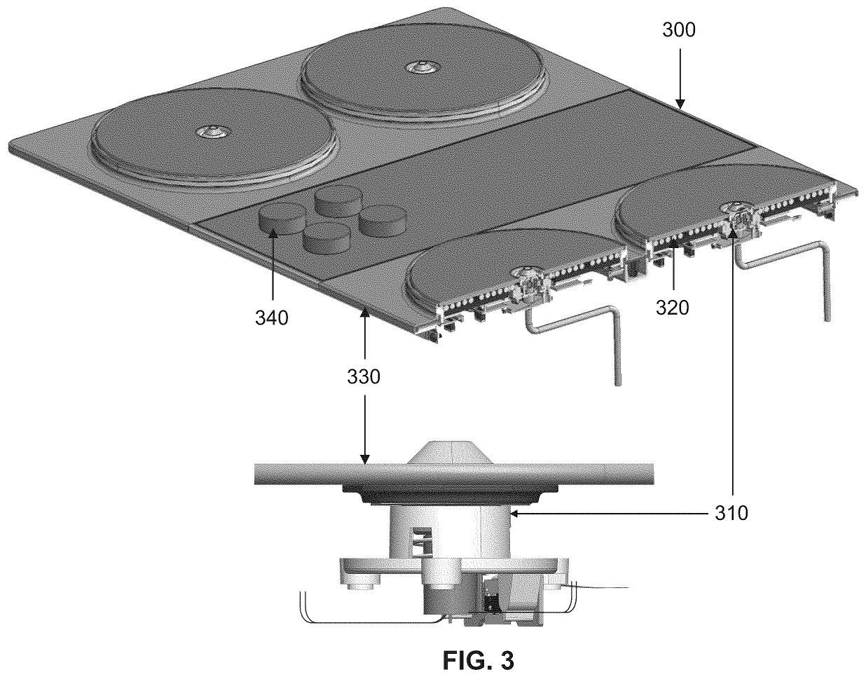

FIG. 3 illustrates an example induction stove 300 with embedded temperature sensor subsystems (TSSYs) 310, according to an implementation. As illustrated, a temperature sensor subsystem 310 may be positioned in the center of a stove coil 320 within the induction stove 300, where the temperature sensor included in the temperature sensor subsystem 310 makes consistent contact with cookware regardless of placement on the stove element. The induction stove 300 may have a glass surface 330, which may be made of a low-thermal expansion glass-ceramic. As illustrated in the figure, in some implementations, the induction stove 300 may include a set of control switches 340, the number of which may match the number of stove coils 320. The control switches may allow a user to control each stove coil 320 to turn on/off and/or set to a specific temperature or heating level. It is to be noted that, while four stove coils 320 are illustrated in FIG. 3, in real applications, there may be any number of stove coils 320 in an induction stove 300. Different stove coils 320 may have the same or different sizes. In addition, while each stove coil 320 in FIG. 3 is shown to have a TSSY 310 disclosed herein, in real applications, one or more stove coils 320 may not have an associated TSSY 310.

It is also to be noted that, while the TSSYs 310 are illustrated as being located in the center of a stove coil, the present disclosure is not limited to such configuration. In real applications, a TSSY may be located at any possible location. In addition, while the TSSYs 310 are illustrated as being integrated into a stove coil, the present disclosure is not limited to such configuration. In some implementations, a TSSY 310 may be a part of a remote sensing system.

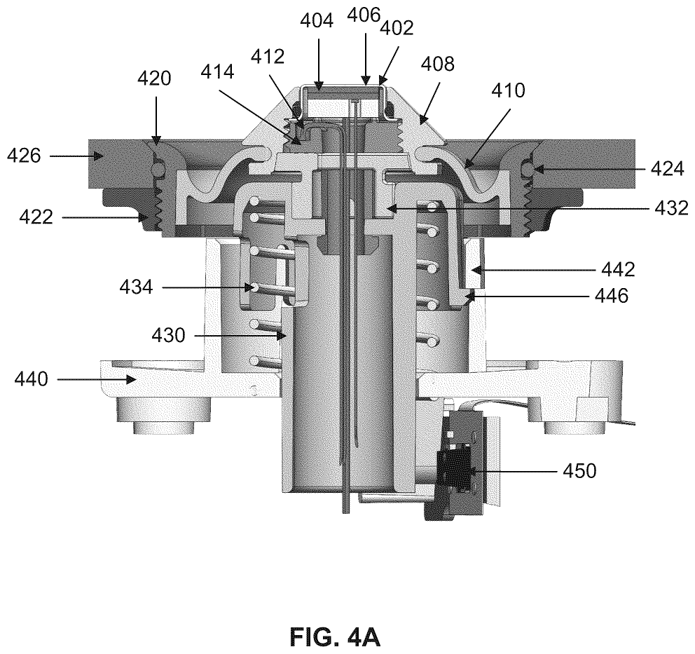

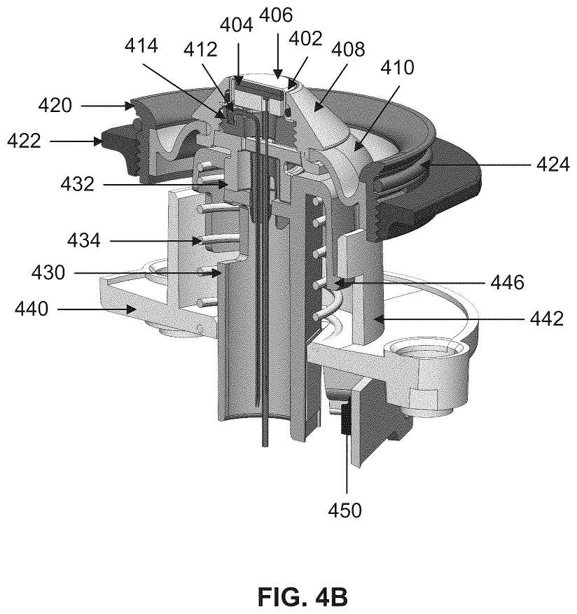

As will be described more in detail later, when there is no placement of cookware, the contact sensor included in a TSSY 310 may be pushed up to a level over the surface of the stove element by a spring disposed underneath, as can be seen more clearly in FIG. 4A. When a piece of cookware is placed onto a stove element, the weight of the cookware may be loaded onto the contact sensor to move the sensor to a lower level (e.g., to keep the top surface of the TSSY flush with the surface of the stove element). The pushing force from the underneath spring may keep the contact sensor in the TSSY 310 in contact with the bottom surface of the cookware consistently. The specific structure of a TSSY 310 is further described in detail with reference to FIGS. 4A-6.

FIGS. 4A and 4B illustrate different sectional views of an exemplary TSSY 310, according to an implementation. As illustrated in the figures, the TSSY 310 includes a temperature sensor package 402 disposed at the central top of the temperature sensor subsystem 310. The sensor package 402 includes one or more contact sensors 404, which may be further packed and protected by a sensor cap 406. The sensor cap 406 may be a circular cap and have a shape of a general glass bottle cap, except that the bottom edge portion of the cap extends out as a lip. As illustrated in FIGS. 4A-4B, the lip portion of the sensor cap 406 may be further held by a sliding ramp 408, which then allows the sensor cap 406 to clamp down the sensor package 402. In some implementations, the sensor cap 406 may be a metal cover configured to adhere strongly to the contact sensor(s) 404. The metal cover on the top of the sensor cap 406 may be made flat with filled edges to make the binding more stable. In one implementation, the metal cover may be a non-ferrous thin sheet that has a minimal thermal mass, such as a stainless steel 316.

The sliding ramp 408 may have a conic outer profile on the top and a large recess on the bottom portion on the outer surface (i.e., the surface facing away from the sensor package 402). The slope of the conic top portion may vary and may have an angle range between 20 degrees to 70 degrees (or another value smaller than 20 degrees or larger than 70 degrees). The bottom recessed portion of the sliding ramp 408 may be curved and round, which may have a shape that matches an upper edge of a shaped elastic diaphragm (or gasket) 410, as can be seen in FIGS. 4A and 4B. The internal surface (i.e., the surface facing the sensor package 402) of the conic portion of the sliding ramp 408 may have a recess that clamps to the lip portion of the sensor cap 406. Below the recess, a set of internal threads may be configured along the internal surface of the sliding ramp 408, as shown in FIGS. 4A and 4B.

In some implementations, below the sensor package 402, there may also include one or more auxiliary sensors 412. The auxiliary sensors may have different functions. In one example, the auxiliary sensors may be configured to detect the change in heat flux as described earlier. In some implementations, the auxiliary sensors 412 may be disposed inside a chamber portion of a sensor holding unit 414, as illustrated in FIGS. 4A and 4B. The sensor holding unit 414 may also provide physical support for the upper sensor package 402. In addition, the sensor holding unit 414 may have a central hollow portion, through which cables or wires for the contact sensor(s) 404 and the auxiliary sensor(s) 412 may pass in order to be connected to a power supply unit and/or controlling unit (not shown).

As can be seen in FIGS. 4A and 4B, in some implementations, the outer surface (i.e., the surface facing the internal side of the sliding ramp 408) of the sensor holding unit 414 may also have a set of threads, which may have a size and shape matching the threads of the sliding ramp 408. The inclusion of the threads along the internal surface of the sliding ramp 408 and the threads along the outer surface of the sensor holding unit 414 may allow the sensor holding unit 414 and the sliding ramp 408 to have a better seal therebetween, thereby preventing liquid, food, or environmental contaminants from getting into the sensor package 402 and/or the auxiliary sensor(s) 412. An O-ring or other sealing mechanism can also be included between the sliding ramp 408 and sensor cap 406.

In some implementations, a diaphragm assembly may be configured to allow for free motion of the temperature sensor package and the sliding ramp 408 while protecting the internal components from liquid, food, or environmental contaminant impingement. Briefly, the clastic diaphragm described herein may be a silicon elastic diaphragm that provides a watertight seal between the movable sensor package and static glass or ceramic cooktop. As illustrated in FIGS. 4A and 4B, the diaphragm assembly may include an upper collar 420, a lower collar 422, an O-ring 424, and the clastic diaphragm 410, among other components. In some implementations, the upper collar 420, the lower collar 422, the O-ring 424, and the clastic diaphragm 410 may have a circular shape, similar to certain other components included in the TSSY 310.

As illustrated in FIGS. 4A and 4B, The clastic diaphragm 410 may have a vertical alignment edge portion that is molded to match the internal surface of the upper collar 420. The alignment edge portion may be fixedly attached to the internal surface of the upper collar 420, for example, by using adhesives or via overmolding two independent materials. The spreading portion of the elastic diaphragm 410 may be not flattened but rather molded to have a waved shape, as can be seen in FIGS. 4A and 4B. The waved shape of the diaphragm 410 may offer more space for extension and thus provide the flexibility to allow the sensor package 402 and the sliding ramp 408 to freely move along a vertical direction. In addition, the concave portion of the waved shape of the diaphragm 410 may also accommodate a small amount of liquid, food, or environmental contaminants if there happens to be some during cooking.

In some implementations, the clastic diaphragm 410 may be configured to seal the moving sensor package in such a way that the seal may be removed during repair. This allows the system to remain waterproof while still being cleanable, and allows for repairing internal components without destroying the temperature sensor subsystem.

The O-ring 424 may be disposed along a recess formed within the upper portion of the external surface of the upper collar 420. Below the recess, the external surface of the upper collar 420 may further include a set of threads, which may match a set of threads formed along the internal surface of the lower collar 422, as can be seen in FIGS. 4A and 4B. The upper collar 420 and the lower collar 422 may form a collar assembly due to the matching of the threads therebetween. The O-ring 424 may further seal the collar assembly to glass 426, which may prevent liquid, food, or environmental contaminants from getting into the stove.

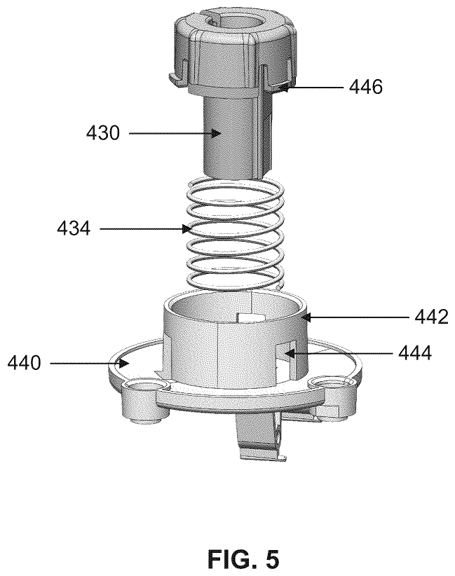

As described elsewhere herein, the temperature sensor subsystem 310 disclosed herein further includes a plunger 430 for holding the sensor package 402 and the auxiliary sensor(s) 412. The sensor package 402 and the auxiliary sensor(s) 412 may be attached to the plunger 430 through a compliant bumper 432. The compliant bumper 432 has a top portion, a neck portion, and a bottom portion, as can be seen in FIGS. 4A and 4B. The top portion may have a flat surface that provides the support for the sensor holding unit 414. The bottom portion may be shaped to match the top circular hollow portion of the plunger 430. The compliant bumper 432 may also include a central hollow portion, allowing the wires or cables for the sensors to pass through. The compliant bumper 432 may allow the sensor package 402 to self-align to the bottom surface of cookware. The specific structure of the plunger 430 is further described in FIG. 5.

FIG. 5 illustrates an exploded view of a plunger assembly, according to an implementation. As illustrated, the plunger assembly includes the plunger 430, a plunger support 442, and a spring 434 disposed between the plunger 430 and the plunger support 442. Also included in the temperature sensor subsystem is a support base 440, which may be molded with the plunger support 442 as a single piece. The plunger 430 may include an inner column portion and an outer cap portion disposed on one side (e.g., the top). When assembled, at least a portion (e.g., the top portion) of the spring 434 may be held between the inner portion and the outer cap portion of the plunger 430. Along the bottom edge of the cap portion of plunger 430, there are a number of protrusions 446, which extends outwards, as shown in FIG. 5. When assembled, these protrusions 446 may pass through openings or slits 444 disposed along the side surface of the plunger support 442. The openings 444 of the plunger support 442 provide constraints for minimum and maximum plunger vertical travel, since the protrusions 446 may be blocked by the top edge of the openings 444 once assembled. The driving force for moving the plunger 430 along a vertical direction may include a pushing-up force from the spring 434 and a pushing down force when cookware is loaded onto a stove element.

It is to be noted that the number of protrusions 446 and the openings 444 are not limited to three as shown in FIG. 5, but may be another different number. The shape and the size of the opening may also vary, which is not limited in the present disclosure.

It is also to be noted that, in some implementations, the plunger assembly may not be movable. Under such circumstances, a spring is not necessary included in the plunger assembly, and certain structure modifications may be further made to the plunger support and the plunger itself due to the exclusion of the spring that controls the movement. In addition, when the plunger assembly is not movable, the top surface of the temperature sensor subsystem may be not necessarily over the cooktop when there is no placement of cookware over the stove element. This may be achieved by configuring a diaphragm with a different shape, among other possible changes to the components included in the diaphragm assembly and/or other components included in the temperature sensor subsystem disclosed herein. For example, a compliant bumper may be not necessarily included in the disclosed temperature sensor subsystem.

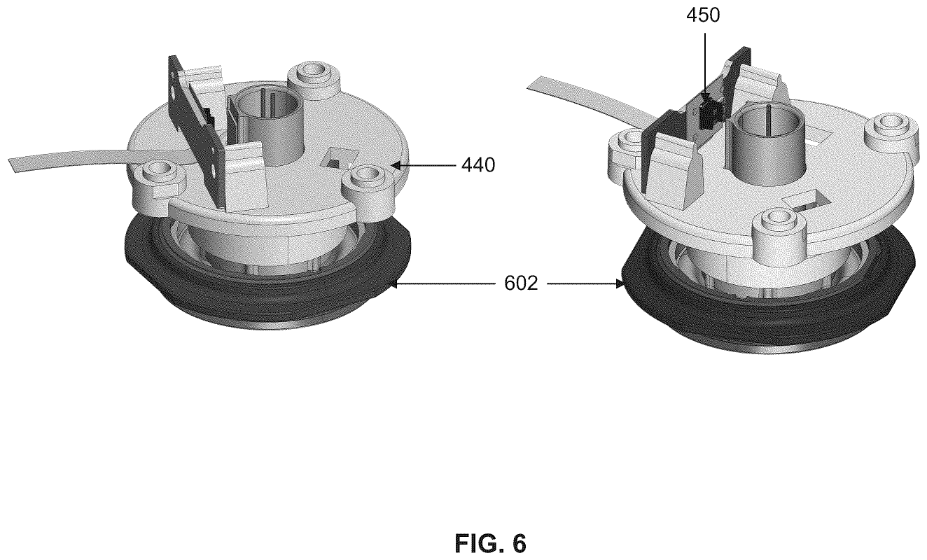

In some implementations, the temperature sensor subsystem 310 disclosed herein may also include a photosensor 450, as shown in FIGS. 4A, 4B, and 6. The photosensor 450 may be a packaged reflective sensor that transmits and receives signals. In some implementations, the photosensor 450 may be configured to determine the calibrated position in the vertical direction, so as to determine the minimum mass of the cookware allowed by the temperature sensor subsystem. In some implementations, the photosensor 450 may be mounted onto the support base 440, as shown in FIGS. 4A, 4B, and 6.

In some implementations, the support base 440 may further mount to a coil scaffolding (also referred to as “coil form”) of the induction stove.

### Assembly Process

In some implementations, when assembling the different components of the temperature sensor subsystem, the diaphragm 410 may be mounted to the glass with threaded clamp collars 420 and 422 and an O-ring 424 or room-temperature vulcanizing silicone (which may be dispensed with a syringe). The packaged temperature sensor subsystem may be then mounted to the coil form included in the induction stove. The glass and the mounted diaphragm may be installed from above.

### Electronics

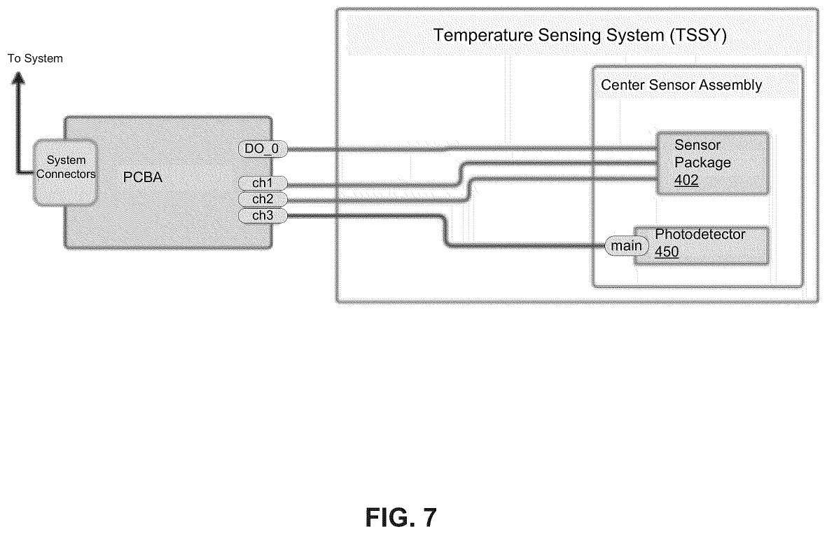

FIG. 7 illustrates example electronics for the temperature sensor subsystem (TSSY), according to an implementation. As illustrated, the sensor package 402 and the photosensor 450 included in the temperature sensor subsystem may be connected to a printed circuit board assembly (PCBA), which may be further connected to the control hardware and software of the induction stove 300. The control hardware and software of the induction stove 300 may be configured to control the temperature sensing as well as the heating process during actual cooking. In one example, the control hardware and software of the induction stove 300 may modulate the power supplied to maintain the temperature at the setpoint as described earlier.

In some implementations, the sensor package 402 and the photosensor 450 may use different numbers of channels when electronically connected to the same PCBA. In some implementations, the sensor package 402 and the photosensor 450 may be electronically connected to different PCBAs. The present disclosure does not limit the ways how the sensor package 402, the auxiliary sensor(s) 412, and the photosensor 450 are electronically connected to the control hardware and software of the induction stove 300.

In some implementations, the electronics of the disclosed temperature sensor subsystem may be configured to have communication units including wireless communication units that allow the wireless control of the disclosed temperature sensor subsystem. For example, through an app installed on a mobile device, a user may wirelessly configure the setpoint temperature, adjust the power level, and so on for the disclosed temperature sensor subsystem.

### Essential Features for Temperature Sensor

As described earlier, the temperature sensor subsystem disclosed herein may provide an accurate and precise temperature measurement for an arbitrary vessel with a very high ramp rate (e.g., greater than 4 degrees C. per second), which also has a very low (e.g., sub-second) lag. Accordingly, when configuring the temperature sensor, the selected sensor may be configured to have a heat capacity as small as possible, which then has the fastest response time to change in cookware temperature/power input. The temperature sensor may also be configured to be non-ferrous and thus have no or minimal interaction with the coil magnetic field. Where components in the temperature sensing system may be self-heated by the field generated by the main coil, protection or field shaping may be used to minimize the impact of self-heating. In addition, the temperature sensor is also configured to have good thermal contact with cookware.

### ADDITIONAL CONSIDERATIONS

In some implementations, the disclosed temperature sensor system may be further improved by miniaturization, circular design, adjusted size, non-ferrous design, and so on. For example, the disclosed temperature sensor system may be made as small as possible, and have a round profile with center wires, as can be seen in FIGS. 3-6. In addition, the size of the power density and wiring may be adjusted for power requirements. To be non-ferrous, the temperature sensor subsystem disclosed herein may use a type T thermocouple, nonferrous RTD, or other similar temperature detection solutions.

The construction and arrangement of the elements of the apparatus as shown in the exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited.

Further, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes, and omissions may be made in the design, operating conditions, and arrangement of the exemplary embodiments without departing from the spirit of the present subject matter.

The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

It should be also understood that as used in the description herein and throughout the claims that follow, the meaning of “a,” “an,” and “the” includes a plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention.

What is claimed is:

1. A temperature sensing device for an induction stove, comprising:
a sensor package including one or more sensors;
a plunger assembly configured to hold the sensor package; and
a support base configured to provide a physical support for the plunger assembly.

2. The temperature sensing device of claim 1, wherein the plunger assembly includes a movable plunger, a fixed plunger support, and a spring disposed between the plunger and the plunger support.

3. The temperature sensing device of claim 1, wherein the one or more sensors include at least one self-heated flux sensor.

4. The temperature sensing device of claim 1, further comprising one or more auxiliary sensors disposed between the sensor package and the plunger assembly.

5. The temperature sensing device of claim 4, wherein the one or more auxiliary sensors are disposed inside a chamber of a sensor holding unit.

6. The temperature sensing device of claim 5, further comprising a compliant bumper disposed between the sensor holding unit and the plunger assembly.

7. The temperature sensing device of claim 6, wherein each of the sensor holding unit, the compliant bumper, and the plunger assembly has a central hollow portion allowing one or more of a cable or wire to pass through.

8. The temperature sensing device of claim 2, wherein the plunger has an inner column portion and an outer cap portion disposed on a top side of the plunger.

9. The temperature sensing device of claim 8, wherein at least a portion of the spring is held between the inner column portion and the outer cap portion of the plunger when the plunger assembly is assembled.

10. The temperature sensing device of claim 9, wherein the outer cap portion of the plunger includes a set of protrusions disposed along a lower edge of the cap portion.

11. The temperature sensing device of claim 10, wherein the plunger support includes a corresponding set of openings disposed on a side surface of the plunger support.

12. The temperature sensing device of claim 11, wherein a protrusion passes through an opening disposed on the side surface of the plunger support and is limited to move within the opening along the predefined direction.

13. The temperature sensing device of claim 5, further comprising a sliding ramp for holding the sensor package and the sensor holding unit together by circularly wrapping the sensor package and the sensor holding unit.

14. The temperature sensing device of claim 13, wherein the sliding ramp has a conic shape on a top portion of the sliding ramp.

15. The temperature sensing device of claim 13, further comprising a sensor cap for covering the one or more sensors, wherein a side portion of the sensor cap is disposed between the sensor holding unit and the sliding ramp.

16. The temperature sensing device of claim 15, wherein the sensor cap includes a non-ferrous thin sheet.

17. The temperature sensing device of claim 13, further comprises a diaphragm assembly for attaching the sensor package and the plunger assembly to a cooktop of the induction stove.

18. The temperature sensing device of claim 17, wherein the diaphragm assembly includes an upper collar, a lower collar, an O-ring, and an elastic diaphragm.

19. The temperature sensing device of claim 18, wherein the diaphragm includes an upper edge portion that extends into a recessed portion located on a lower edge of the sliding ramp.

20. A method for assembling a temperature sensing device, the temperature sensing device including a temperature sensor subsystem that includes a sensor package, a sensor holding unit, a compliant bumper, a plunger assembly, and a support base, and the method comprising:
attaching the plunger assembly to the support base;
disposing the compliant bumper inside a top hollow portion of a plunger included in the plunger assembly;
positioning the sensor holding unit over the compliant bumper, and positioning the sensor package over the sensor holding unit; and
clamping down the sensor package and the sensor holding unit using a sliding ramp.
